(19) United States
(12) Patent Application Publication
(10) Pub. No.: US 2026/0321926 A1
(43) Pub. Date: Oct. 15, 2026

(54) PROTECTION DEVICE FOR PROPULSION BATTERIES AGAINST CONDUCTIVE ENERGY DISCHARGE

(71) Applicant: Scania CV AB, Södertälje (SE)

(72) Inventor: Johan LINDSTRÖM, Stockholm (SE)

(73) Assignee: Scania CV AB, Södertälje (SE)

(21) Appl. No.: 19/104,735

(22) PCT Filed: Aug. 22, 2023
(86) PCT No.: PCT/SE2023/050851

§ 371 Date: Feb. 19, 2025

(30) Foreign Application Priority Data
Aug. 26, 2022 (EP) 22192381.6

(51) Int. Cl. H01M 50/574; B60L 3/00; B60L 50/64; H01M 10/42; H01M 50/224; H01M 50/249

(52) U.S. Cl. CPC H01M 50/574; B60L 3/00; B60L 50/64; H01M 10/4257; H01M 50/224; H01M 50/249; H01M 2220/20

(57) ABSTRACT

The present application relates to a protection device against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

### TECHNICAL AREA

The present application relates to the build-up of stray capacitances in large propulsion battery systems for electrically driven vehicles.

### BACKGROUND OF INVENTION

When developing heavy electric vehicles such as trucks, lorries and busses, large battery systems are required for providing the necessary capacity and driving range between charging. These battery systems comprise battery packs with a number of battery modules, where each module comprises a plurality of battery cells. Each cell is built up by an anode and a cathode separated by a separator and immersed in an electrolyte solution, that may be placed in a metal casing. The cells can be either prismatic or cylindrical. The cells are assembled or stacked in compartments, often called modules, to form battery units. These battery units are then often placed together in structures to form battery packs. Large vehicles requiring large amounts of energy often have several battery packs placed in different locations on the vehicle in order to distribute the weight and also be able to handle the battery packs during maintenance or replacement.

Since many of the battery prismatic cells have metal casings, often of aluminium, there is a risk of corrosion in the cell. In order to handle this, the casing is often connected galvanically to the cathode of the cell. This is often done by welding the cathode to the aluminium casing, thereby providing a galvanic contact of very low ohm.

Stray capacitances are also a problem in electric vehicles, particularly heavy duty vehicles. Stray capacitances can be built up between the vehicle propulsion electrical system and the ground of the vehicle, to which the metal casing of the battery modules or packs are connected. Furthermore, when handling the issue with corrosion using a low ohm connection as above, the connection of low ohm results in high peak currents during a potential discharge of the stray capacitance. There is thus a risk of a high peak current discharge of the stray capacitance if a person comes in contact with a conductor of the electrical vehicle propulsion system.

The danger with a discharge of the stray capacitance increases with the size of the battery system. This is because the stray capacitance is created between the surfaces between the earth of the chassis, i.e. the casings of the modules and the casing of the cells, forming a plurality of plate capacitors and since the large battery systems comprise a very large number of cells, the stray capacitance can be quite significant. This can be understood by the equation of the capacitance for a plate capacitor:

$$C = ε \frac{A}{d}$$

where d is the distance between plates, in the case with batteries the distance between the cells and the surrounding metal casings of the modules. A is the area where two plates meet and ε is the permittivity of the isolating material. In order to create as compact as possible battery systems, there is a desire to minimize the size of the battery packs, wherein the distance between the cells and the module casings is reduced, and as seen from the above equation, reduction of the distance d, will lead to increased stray capacitance values.

With large battery systems, there is a risk that the discharge of stray capacitance can reach levels that can be lethal to humans, if the discharge passes a human body that comes in contact with a conductor. There is further a desire to increase the operating voltage of the battery systems, in particular with large capacity systems. However, an increase in the voltage leads to an increase in the discharge energy because the discharge energy is a function of U², thus even further increasing the risk of lethal situations. This may in particular be the case during maintenance of the vehicle, removing or replacing battery modules. There is thus a challenge to balance the desire of compact battery systems with large capacity and higher voltages with the safety aspect regarding stray capacitance in those systems.

### BRIEF DESCRIPTION OF INVENTION

The present application aims to reduce the risk of personal injuries as described above. This aim is solved by a protection device according to the independent patent claim. Preferable embodiments form the subject of the dependent patent claims.

According to main aspect, a protection device against electrical discharge through a human body is provided, which protection device may comprise a conductive element electrically connected between a cathode of a battery cell of a vehicle propulsion battery module and a metal casing surrounding the battery cell, which conductive element may display electrical resistive properties for limiting stray capacitance energy through a human body if a person comes in contact with a conductor of the battery cell.

This solution will limit the discharge current caused by the stray capacitance between the cell casings and the surfaces of the modules, wherein released energy of the stray capacitance through a person coming in electrical contact with the battery system is reduced due to the division of voltage between the inner resistance, also referred to as the internal resistance, of the person and the resistance of the conductive elements, since the internal resistance of the person is now connected in series with the resistance of the conductive element. The internal resistance of the human body depend on a number of factors and may vary from 500 Ohm and upwards. Taking a cautious approach the internal resistance can be considered to be around 500 Ohm. In order to reduce the current through the body of the person the conductive element may display an electrical resistance having at least the same order of magnitude as the internal resistance of a human body. Preferably the conductive element is provided with a resistance greater than the internal resistance of the human body, e.g. 5-10 times greater. The conductive element may thus display an electrical resistance of at least 100 Ohm, preferably at least 500 Ohm. More preferably, the resistance of the conductive element is in the range of 1000-5000 Ohm, e.g. 2500-5000 Ohm. Thereby the released energy is reduced a great deal. Furthermore, by providing a resistance in the range of 2500-5000 Ohm, there is less risk that the element burns up during an isolation fault, compared to conductive elements having a lower resistance.

By providing a conductive element connected between a cathode of a battery cell of a vehicle propulsion battery module and a metal casing surrounding the battery cell where the conductive element display an electrical resistance as described herein, it is ensured that the released energy of the stray capacitance through a person coming in electrical contact with the battery system is reduced to safe levels, i.e. levels which a person can handle. Providing a resistance of the above magnitude in the manner described above achieves this result.

The conductive element of the protection device may comprise an electrical resistor.

According to a further aspect, a battery cell for a vehicle propulsion battery is provided, which battery cell may be provided with a metal casing and comprising a protection device as described above. In this regard, a cathode of the battery cell may have a galvanic connection to the metal casing.

According to yet an aspect, a battery module comprising several battery cells is provided, where at least a majority of the battery cells may be provided with a protection device as described above. With majority is herein meant “more than half”. Thus, more than half of the battery cells may be provided with a protection device as described above. Further, the battery module may comprise a metal casing connectable to the ground of an electric vehicle. Preferably, several such battery modules may be comprised in a propulsion battery system. In this regard, the capacity of the propulsion battery system may be larger than 300 kWh, because a larger propulsion battery usually require a greater amount of battery cells and since if the number of battery cells increase, the area contributing to stray capacitances increase and thereby the level of discharge energy increases and which require protection devices as described above.

These and other aspects of, and advantages with, the present invention will become apparent from the following detailed description of the invention and from the accompanying drawings.

### BRIEF DESCRIPTION OF DRAWINGS

In the following detailed description of the invention, reference will be made to the accompanying drawings, of which

FIG. 1 is a schematic cross-sectional side view of a propulsion battery module;

FIGS. 2-3 are schematic views from above of the propulsion battery module of FIG. 1,

FIG. 4 is a schematic view of addition of stray capacitance in a propulsion battery module of FIG. 1,

FIG. 5 is a view of the module provided with a protection device according to the present application,

FIG. 6 is a view corresponding to FIG. 4 with the protection device according to the application, and

FIG. 7 is a schematic side view of an electrical vehicle that may be provided with the protection device according to the application.

### DETAILED DESCRIPTION OF THE INVENTION

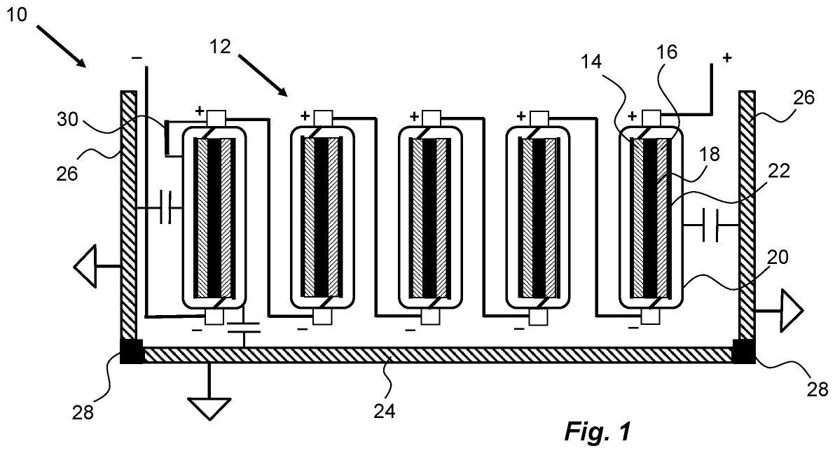

FIG. 1 shows schematically a battery module 10 to be comprised in a battery system for propelling a vehicle, comprising a plurality of Li-Ion battery cells 12. Each cell 12 comprises a cathode plate 14 and an anode plate 16 with a separator sheet 18 between the cathode and the anode. The plates and sheet are placed in a metal casing 20, usually of aluminium, and the casing 20 is filled with an electrolyte solution. Separators 22 are also arranged between the plates 14, 16 and the casing 20. The casing 20 could be cylindrical or rectangular. The cathode plate 14 and the anode plate 16 are each provided with a tab or connection point for electrical connection with other cells for forming a battery module 10. A module 10 is often comprised of generally rectangular metal casing with a bottom 24 and sides 26. These surfaces are often separated by insulating material 28. The module is then closed by an upper cover (not shown). The metal casing of the module 10 is further electrically connected to the ground of the vehicle.

A number of battery modules are then inter-connected electrically in parallel and series for forming propulsion battery packs for electrically driven vehicles. For large and heavy vehicles, the total capacity of the battery packs of a battery system for a vehicle is often above 300 kWh and this means that several battery packs are installed in the vehicle.

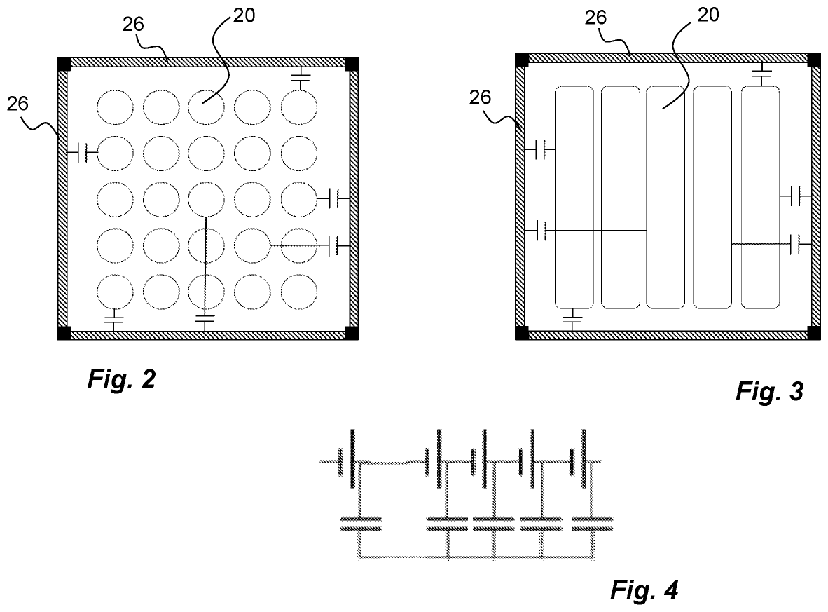

In order to prevent galvanic corrosion in the Li-Ion cells 12, the cathode 14 of each cell is provided with a galvanic connection 30 to its casing 20, FIG. 1, in order to obtain a galvanic contact with a very low ohm value. In FIG. 1 only one such galvanic connection 30 is shown to simplify understanding. This low ohm contact may result in a high peak current during discharge of the stray capacitance between the propulsion battery system and the earth of the vehicle. The stray capacitance is formed between the cell casings 20 of the cells arranged in the module 10 and the surfaces 24, 26 of the modules, the bottom and sides, that function as plate capacitors, see FIGS. 2 and 3, showing cylindrical and prismatic cells. According to Thevenin's theorem, the capacitance influence from all surfaces are added regardless if they have different potential from the battery cells. Hence, each and all of the surfaces of the cell casings will interact with the surfaces of the module, creating stray capacitances that are added, as seen in FIG. 4.

For large battery systems as mentioned above, with large areas from the casings of the plurality of modules, the stray capacitance value can be quite considerable, and can pose a serious risk of injury if a person comes in contact with a conductor of the propulsion battery system and a discharge of stray capacitance passes through the person's body.

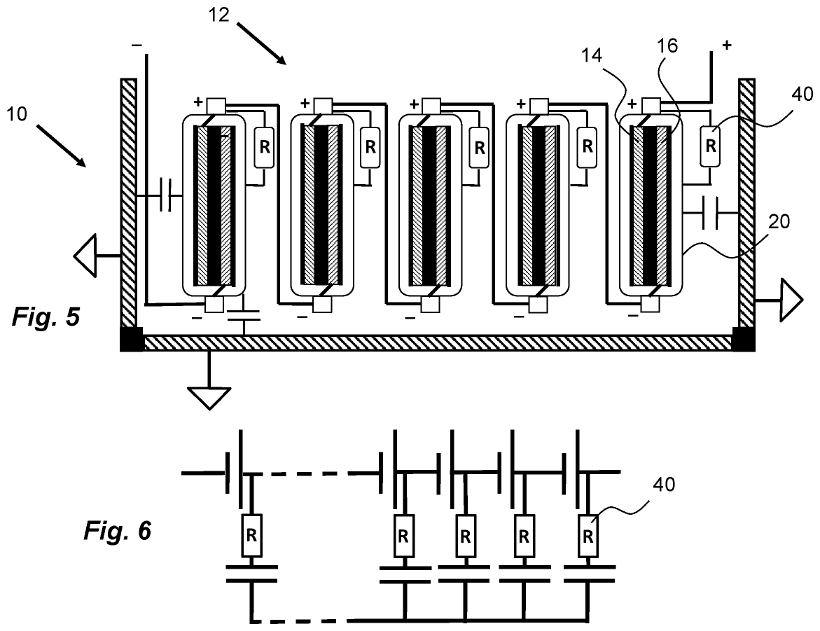

In order to reduce the risk of a discharge of stray capacitance through a human body in an above scenario, a protection device is provided. It comprises a conductive element 40 connected between the cathode of the battery cell and its metal casing as seen in FIG. 5. The conductive element 40 is provided with an electrical resistance which limits the discharge current caused by the stray capacitance between the cell casings and the surfaces of the modules, wherein released energy of the stray capacitance through a person coming in electrical contact with the battery system is reduced due to the division of voltage between the internal resistance of the person (e.g. from about 500 ohm) and the resistance of the conductive elements. Preferably, the conductive element 40 is therefore provided with a resistance at least in the order of the internal resistance of the human body in order to ensure that the released energy will be low enough for the person to handle. Preferably the conductive element is provided with a resistance greater than the internal resistance of the human body, e.g. 5-10 times greater. Thereby the released energy will be reduced even further. The resistance of the conductive element may thus be 100 ohm or higher, e.g. 500 Ohm or higher. Preferably the resistance of the conductive element is in the range of 1000-5000 Ohm, e.g. 2500-5000 Ohm. The conductive element could be a resistor.

As a high safety measure, all cells of a module may be provided with such a conductive element. FIG. 6 show the electrical circuit for the case described, where every cell is provided with a conductive element. However, depending on the size of the modules and the number of modules, the stray capacitance generated may not be so high that all cells in a module need to be provided with this conductive element. This will have to be assessed for each type and size of battery system and vehicle.

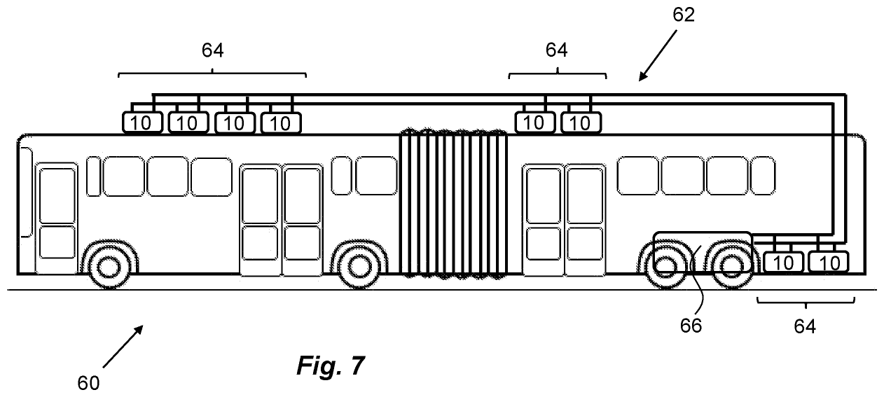

FIG. 7 shows an example of an electrically driven vehicle 60, here an articulated commuter bus is shown. As seen, the bus is arranged with a propulsion battery system 62 comprising a number of battery packs 64, in turn comprising a number of battery modules 10 placed on different locations, both on the roof and adjacent an electric machine 66 for propelling the vehicle. This type of vehicle requires a large number of battery cells for providing the energy capacity needed. In this context, it is important to utilize the solution according the application for minimizing the effect of stray capacitance in order to greatly reduce the risk of serious adverse effects if a person comes in contact with a conductor of the battery system. It is however to be understood that insulation of the conductors of a battery system for vehicles is the main protection against electrical shocks and that the present application is an additional safety measure.

It is to be understood that the embodiment described above and shown in the drawing is to be regarded only as a non-limiting example and that the present application can be modified in many ways within the scope of the patent claims.

1. A protection device against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

2. A protection device according to claim 1, wherein the conductive element displays an electrical resistance at least in an order of an internal resistance of a human body.

3. A protection-Protection device according to claim 1, wherein the conductive element displays an electrical resistance 5-10 times greater than an internal resistance of a human body.

4. A protection device according to claim 1, wherein said conductive element displays an electrical resistance of at least 100 Ohm.

5. A protection device according to claim 1, wherein said conductive element displays an electrical resistance in a range of either: 1000-5000 Ohm or 2500-5000 Ohm.

6. A protection device according to claim 1, wherein the conductive element comprises an electrical resistor.

7. A battery cell for a vehicle propulsion battery, which battery cell is provided with a metal casing and comprising a protection device for protecting against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

8. A battery cell according to claim 7, wherein a cathode of the battery cell has a galvanic connection to said metal casing.

9. A battery module comprising several battery cells, where at least a majority of the battery cells are provided with a protection device for protecting against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

10. A battery module according to claim 9, comprising a metal casing connectable to a ground of an electric vehicle.

11. A propulsion battery system comprising several battery modules, wherein each battery module comprises several battery cells, where at least a majority of the battery cells are provided with a protection device for protecting against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

12. A propulsion battery system according to claim 11, wherein a capacity of the propulsion battery system is larger than 300 kWh.

13. A vehicle comprising a propulsion battery system, said propulsion battery system comprising several battery modules, wherein each battery module comprises several battery cells, where at least a majority of the battery cells are provided with a protection device for protecting against electrical discharge through a human body, which protection device comprises a conductive element electrically connected between a cathode of a battery cell of a vehicle propulsion battery module and a metal casing surrounding said battery cell, which conductive element displays electrical resistive properties for limiting stray capacitance energy through a human body if a person comes in contact with a conductor of the battery cell.

14. A battery module according to claim 9, wherein the conductive element displays an electrical resistance at least in an order of an internal resistance of a human body.

15. A battery module according to claim 9, wherein the conductive element displays an electrical resistance 5-10 times greater than an internal resistance of a human body.

16. A battery module according to claim 9, wherein said conductive element displays an electrical resistance of at least 100 Ohm or in a range of either: 1000-5000 Ohm or 2500-5000 Ohm.

17. A battery module according to claim 9, wherein the conductive element comprises an electrical resistor.

18. A propulsion battery system according to claim 11, wherein the conductive element displays an electrical resistance at least in an order of an internal resistance of a human body.

19. A propulsion battery system according to claim 11, wherein the conductive element displays an electrical resistance 5-10 times greater than an internal resistance of a human body.

20. A propulsion battery system according to claim 11, wherein said conductive element displays an electrical resistance of at least 100 Ohm or in a range of either: 1000-5000 Ohm or 2500-5000 Ohm.
